(19) United States
(12) Patent Application Publication
(10) Pub. No.: US 2004/0260683 A1
(43) Pub. Date: Dec. 23, 2004

(54) Techniques for information dissemination using tree pattern subscriptions and aggregation thereof

(76) Inventors: Chee-Yong Chan, Singapore (SG); Wenfei Fan, Somerset, NJ (US); Pascal Amedee Felber, Chateauneuf de Grasse (FR); Minos N. Garofalakis, Morristown, NJ (US); Rajeev Rastogi, New Providence, NJ (US)

Correspondence Address: Ryan, Mason & Lewis, LLP, Suite 205, 1300 Post Road, Fairfield, CT, 06824, US

(21) Appl. No.: 10/600,996

(22) Filed: Jun. 20, 2003

(51) Int. Cl. G06F 7/00

(52) U.S. Cl. 707/3

(57) ABSTRACT

A set of subscriptions are provided, where one or more subscriptions each comprises a tree pattern, and a tree pattern comprises one or more interconnected nodes having a hierarchy and adapted to specify content and structure of information. The set of subscriptions is used to select information for dissemination to users. Generally, the one or more subscriptions having the tree pattern describe information the users are interested in receiving. Techniques are presented for determining an aggregation from the subscriptions, where the aggregation comprises a set of aggregate patterns. The set of subscriptions may comprise a number of tree patterns, and the aggregate patterns generally also comprise tree patterns comprising one or more interconnected nodes having a hierarchy and adapted to specify content and structure of information. The set of aggregation patterns is smaller than the set of subscriptions and can be made to fit any space constraint.

### FIELD OF THE INVENTION

The present invention relates generally to communication over networks, and, more particularly, to communication of electronic information over networks.

### BACKGROUND OF THE INVENTION

Large amounts of document transfer occur over networks every day, and standards have been implemented to make the document transfer easier. On the Internet, for instance, extensible markup language (XML) has become a dominant standard for encoding and exchange of documents, including electronic business transactions in both Business-to-Business (B2B) and Business-to-Consumer (B2C) applications. Given the rapid growth of document traffic on the Internet, the effective and efficient delivery of documents such as XML documents has become an important issue. Consequently, there is growing interest in the area of content-based filtering and routing, which addresses the problem of effectively directing high volumes of document traffic to interested users based on document contents. In conventional routing, packets are routed over a network based on a limited, fixed set of attributes, such as source/destination Internet protocol (IP) addresses and port numbers. By contrast, content-based document routing is based on information in document contents, and is therefore more flexible and demanding.

In a system that provides filtering and routing for document dissemination, users typically specify their subscriptions. Subscriptions indicate the type of content that users are interested in, and generally use some pattern specification language. For each incoming document, a content-based document router matches the document contents against a set of subscriptions to identify a set of interested users, and then routes the document to any interested users. Thus, in content-based routing, the “destination” of a document is generally unknown to the data producer and is computed dynamically based on the document contents and a set of subscriptions. Effective support for scalable, content-based routing is crucial to enabling efficient and timely delivery of relevant documents to a large, dynamic group of users.

Unfortunately, there are problems with current document dissemination systems that limit scalability. One problem is space requirements, as user subscriptions can become quite large, potentially having gigabytes of information. A competing problem is the speed at which a determination can be made as to whether a document should be disseminated to users. Ideally, as network streaming speed increases, the speed at which document comparison takes place also should increase. Both speed and space requirements are impacted by increased numbers of subscriptions and therefore affect scalability, as more subscriptions place burdens on both speed and space.

Consequently, a need exists for information dissemination techniques for networks that allow a high number of subscriptions yet also provide high speed document dissemination.

### SUMMARY OF THE INVENTION

The present invention provides techniques that provide information dissemination through, among other things, subscriptions in the form of tree patterns and tree pattern aggregation.

In an aspect of the invention, a set of subscriptions are provided, where one or more subscriptions comprise a tree pattern. A tree pattern illustratively comprises one or more interconnected nodes having a hierarchy and are adapted to specify content and structure of information. The set of subscriptions is used to select information for dissemination to users. Generally, the one or more subscriptions having the tree pattern describe information the users are interested in receiving. Illustratively, subscriptions that use tree patterns are more expressive and practical than conventional subscriptions.

In another aspect of the invention, techniques are presented for determining an aggregation from the subscriptions. An aggregation may be determined from the set of subscriptions, and the aggregation comprises a set of aggregate patterns. The set of subscriptions may comprise a number of tree patterns, and the aggregate patterns generally also comprise tree patterns comprising one or more interconnected nodes having a hierarchy and adapted to specify content and structure of information.

Illustratively, the set of aggregate patterns is smaller than the set of subscriptions in that the number of aggregate pattern is less than the number of tree patterns in the subscriptions and the number of nodes in the set of aggregate patterns is smaller than the number of nodes in the set of subscriptions. Broadly, the aggregate patterns “compress” the subscriptions and therefore provide smaller memory requirements and generally faster comparisons between information and the aggregation. There may be some loss of precision due to the “compression,” but the loss of precision is generally kept low through techniques described below.

In a further aspect of the invention, the aggregation techniques can be applied using a space constraint. The space constraint can be imposed, for example, by system configuration. The space constraint may be used to limit the size of memory available for storing an aggregation. The space constraint is generally expressed in bytes and can be measured with respect to the number of nodes in the set of aggregate patterns of the aggregation.

In another aspect of the invention, a systematic study of least upper bound patterns is described. The least upper bound of a set of tree patterns can be considered a most precise aggregation of the set. A theoretical foundation for the existence of the most precise aggregation is described, as is a complexity of the computation for the least upper bound, techniques for computing a least upper bound, and techniques for minimizing a least upper bound.

In yet another aspect of the invention, when the least upper bound of a set of subscriptions is larger than the given space constraint, techniques are presented for computing an approximation of the least upper bound in order to meet the space constraint. The least upper bound of a set of subscriptions may be considered to be the most precise aggregation for the set. The approximation of the least upper bound is an aggregation that satisfies the space constraint and minimizes loss of precision as much as possible. The approximation may be determined by setting a candidate set of tree patterns to be the tree patterns in the subscriptions. The following steps may be performed and iterated: a set of candidate aggregate patterns may be identified from the plurality of tree patterns and similar tree patterns determined from the candidate set of tree patterns; each candidate aggregate pattern may be pruned by deleting or merging nodes; a chosen tree pattern may be selected from the candidate aggregate patterns having a predetermined marginal gain; and all tree patterns, in the candidate set of tree patterns, that are contained in the chosen tree pattern may be replaced by the chosen tree pattern.

Additionally, the pruning process may be directed by using selectivity of information, in that only nodes with low selectivity, i.e., low frequency of document matching, can be removed. Thus, loss of preciseness is reduced. The frequency of matching is determined by sampling information and thereby determining selectivity of the information.

### BRIEF DESCRIPTION OF THE DRAWINGS

FIG. 1 is a block diagram of an exemplary communication system providing document routing using techniques of the present invention;

FIGS. 2A through 2E illustrate example tree patterns and an XML tree;

FIGS. 3A through 3D illustrate examples of tree patterns;

FIGS. 4A and 4B show pseudocode of exemplary methods used to compute a least upper bound;

FIGS. 5A and 5B show pseudocode of exemplary methods used to compute containment, which determines whether one tree pattern is contained in another;

FIGS. 6A through 6I illustrate examples of tree patterns;

FIG. 7 shows pseudocode of an exemplary method for tree pattern selectivity estimation; and

FIG. 8 shows pseudocode of an exemplary method for tree pattern aggregation.

### DETAILED DESCRIPTION

For ease of reference, the present disclosure is divided into the following sections: Introduction; Problem Formulation; Computing Precise Aggregates; and Selectivity-Based Aggregation Methods.

1. Introduction

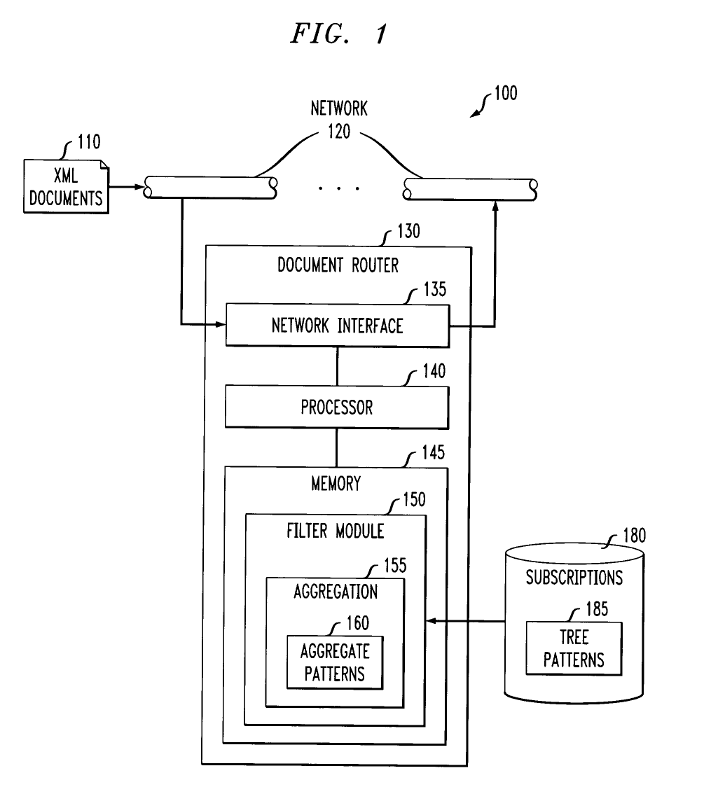

Turning now to FIG. 1, a communication system 100 is shown. Communication system 100 comprises a network 120, a document router 130, and subscriptions 180. Network 120 is used to transport a number of XML documents 110 and generally transports a stream of such XML documents 110. XML documents 110 contain information to be routed to users. Document router 130 comprises a network interface 130 coupled to a processor 140, which is coupled to memory 145. Memory 145 comprises a filter module 145 that comprises an aggregation 155. The aggregation 155 comprises a set of aggregate patterns 160. The subscriptions 180 comprise a set of tree patterns 185. In this example, subscriptions 180 are separate from document router 130 and could be accessed, for example, over network 120.

Broadly, XML documents 110 pass through network 120. In a conventional communication system 100, the document router 130 selects, via filter module 150, XML documents 110 by comparing the documents to the subscriptions 180. The XML documents 110 that compare favorably with subscriptions 180 are routed to users. It should be noted that conventional systems generally did not use tree patterns 185. As explained above, as subscriptions 180 increase, the memory requirement for subscriptions 180 increases. Additionally, the speed at which comparisons between the XML documents 110 and the subscriptions 180 need to be performed by the filter module 150 increases.

The present invention solves these problems by, among other things, providing subscriptions 180 that are tree patterns 185. The tree patterns 185 have interconnected nodes (shown below) having a hierarchy and adapted to specify content and structure of information. Broadly, the subscriptions 180 describe information that users are interested in receiving. One suitable technique for describing the tree patterns is by using the XML pattern specification language called XPath, as described in XML Path Language (XPath) 1.0, World Wide Web Consortium (W3C) (1999), the disclosure of which is hereby incorporated by reference. Although XML documents will be described herein for use with the present invention, the present invention may be used for any hierarchically structured documents. Similarly, although tree patterns using XPath are described herein, any hierarchical patterns having interconnected nodes and a tree structure may be used.

The present invention also provides aggregation of subscriptions that are tree patterns. Broadly, given a large volume of potential users, system scalability and efficiency mandate the ability to judiciously aggregate the set of subscriptions 180 to a smaller set of patterns. Goals are to both reduce the storage space requirements of the subscriptions 180, as well as speed up the filtering of incoming XML document 110 traffic. For instance, a document router 130 in a B2B application may choose to aggregate subscriptions to create aggregation 155 based on geographical location, affiliation, or domain-specific information (e.g., telecommunications). Aggregation generally involves compressing an initial set of subscriptions 180, S, into a smaller set A such that any document that matches some subscription in S also matches some subscription in A, and furthermore the size of A is larger than a predefined space constraint. However, since there is typically a “loss of precision” associated with such aggregation, the documents matched by the aggregated set A is, in general, a superset of those matched by the original set S. As a result, an XML document 110 may be routed to users who have not subscribed to it, thus resulting in an increase in the amount of unwanted document traffic. In order to avoid such spurious forwarding of documents, it is desirable to minimize the number of such “false matches” (e.g., which minimize the loss in precision) with respect to the given space constraint for the aggregated subscriptions.

The present disclosure describes, among other things, a subscription aggregation problem where subscriptions 180 are specified using an expressive model of tree patterns 185. Tree patterns 185 represent an important subclass of, for instance, XPath expressions that offers a natural means for specifying tree-structured constraints in XML and lightweight directory access protocol (LDAP) applications. Compared to earlier work based on attribute/predicate-based subscriptions, effectively aggregating tree patterns 185 poses a much more challenging problem since subscriptions 180 involve both content information (e.g., node labels) as well as structure information (e.g., parent-child and ancestor-descendant relationships). Briefly, a tree pattern aggregation problem can be stated as follows: Given an input set of tree patterns 185 (referred to as “S,” as the subscriptions 180 are assumed for exposition to be tree patterns) and a space constraint, aggregate S into a smaller set of aggregate patterns 160 that meets the space constraint, and for which the loss in precision due to aggregation is minimized.

Thus, the document router 130 can create a set of aggregate patterns 160 from the tree patterns 185. The aggregation 155 that results is smaller than the subscriptions 180 and can more appropriately fit in memory 145.

It should be noted that the memory 145 may contain a routing table (not shown) that correlates aggregate patterns 160 with users. For example, one user may request documents concerning space travel, and the aggregate patterns 160 associated with space travel will have corresponding destination addresses for the user. The routing table is used by document router 130 to route XML documents 110 to the user.

The filter module 150 is a module which when executed by processor 140 implements all or a portion of the present invention. The techniques described herein may be implemented through hardware, software, firmware, or a combination of these. Additionally, the techniques may be implemented as an article of manufacture comprising a machine-readable medium, as part of memory 145 for example, containing one or more programs that when executed implement embodiments of the present invention. For instance, the machine-readable medium may contain a program configured to perform some or all of the steps of the present invention. The machine-readable medium may be, for instance, a recordable medium such as a hard drive, an optical or magnetic disk, an electronic memory, or other storage device.

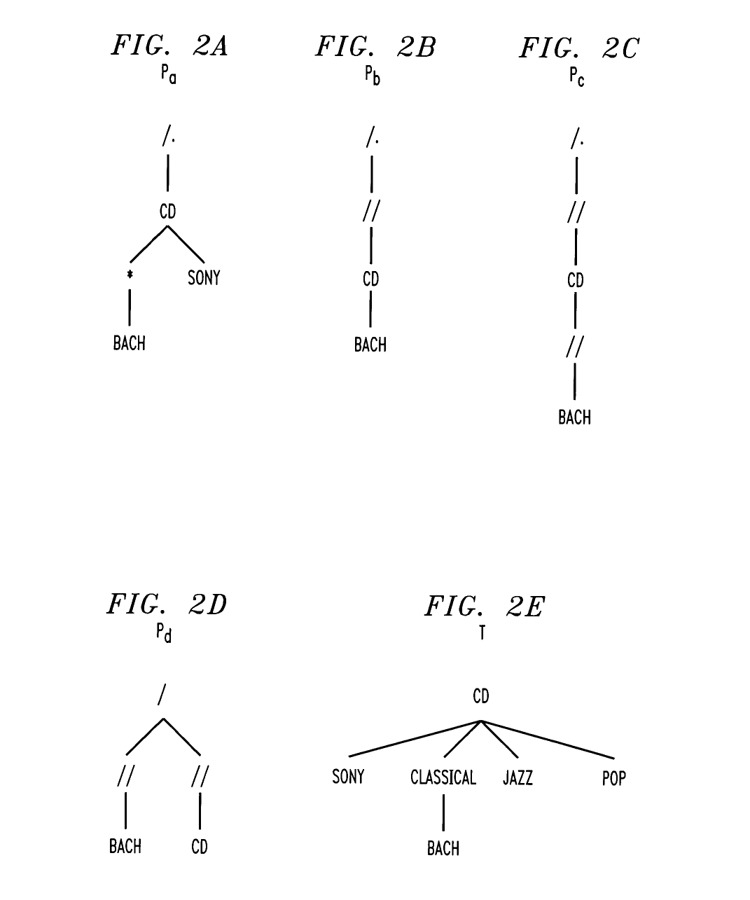

The following example is illustrative of problems associated with tree patterns 185. Consider the two similar tree-pattern subscriptions pₐ and p_{b}, shown in FIGS. 2A and 2B, where pₐ matches any document with a root element labeled “CD” that has both a sub-element labeled “SONY” as well as a sub-element with an arbitrary label that in turn has a sub-element labeled “Bach”. Also, p_{b} matches any document that has some element labeled “CD” with a sub-element labeled “Bach”. Here the node labeled ‘*’ (called a “wildcard”) matches any label, while the node labeled ‘//’ (called a “descendant”) matches some (possibly empty) path. The XML document T shown in FIG. 2E matches or “satisfies” pₐ but not p_{b}, because the sub-element labeled “Bach” in T does not have a parent element labeled “CD”. For efficiency reasons, one might want to aggregate the set of tree patterns {pₐ, p_{b}} into a single tree pattern. Two examples of aggregate tree patterns for {pₐ, p_{b}} are p_{c} and p_{d}, shown in FIGS. 2C and 2D respectfully, since any document that satisfies pₐ or p_{b} also satisfies both p_{c} and p_{d}. Although both p_{c} and p_{d} have the same number of nodes, p_{c} is intuitively “more precise” than p_{d} with respect to {pₐ, p_{b}} since p_{c} preserves the ancestor-descendant relationship between the “CD” and “Bach” elements as required by pₐ and p_{b}. Indeed, any XML document that satisfies p_{c} also satisfies p_{d} (and thus, as explained in detail below, it is said that p_{d} “contains” p_{c}).

The present disclosure describes efficient methods for deciding tree pattern containment, minimizing a tree pattern, and computing the most precise aggregate (i.e., the “least upper bound”) for a set of patterns. Additionally, an efficient method is proposed that exploits coarse statistics on the underlying distribution of XML documents to compute a “precise” set of aggregate patterns within the allotted space budget. Specifically, disclosed techniques employ document statistics to estimate the selectivity of a tree pattern, which is also used as a measure of the preciseness of the pattern. Thus, an aggregation problem can be reduced to finding a compact set of aggregate patterns with minimal loss in selectivity, for which a greedy heuristic is presented herein.

The usefulness of the present invention on tree patterns and their aggregation is not limited to content-based routing, but also extends to other application domains such as the optimization of XML queries involving tree patterns and the processing and dissemination of subscription queries in a multicast environment (e.g., where aggregation can be used to reduce server load and network traffic). Further, the present invention is complementary to recent work on efficient indexing structures for XPath expressions. The focus of earlier research was to speed up document filtering with a given set of XPath subscriptions using appropriate indexing schemes. In contrast, the present invention focuses on effectively reducing the volume of subscriptions that need to be matched in order to ensure scalability given bounded storage resources for routing.

2. Problem Formulation

2.1 Definitions

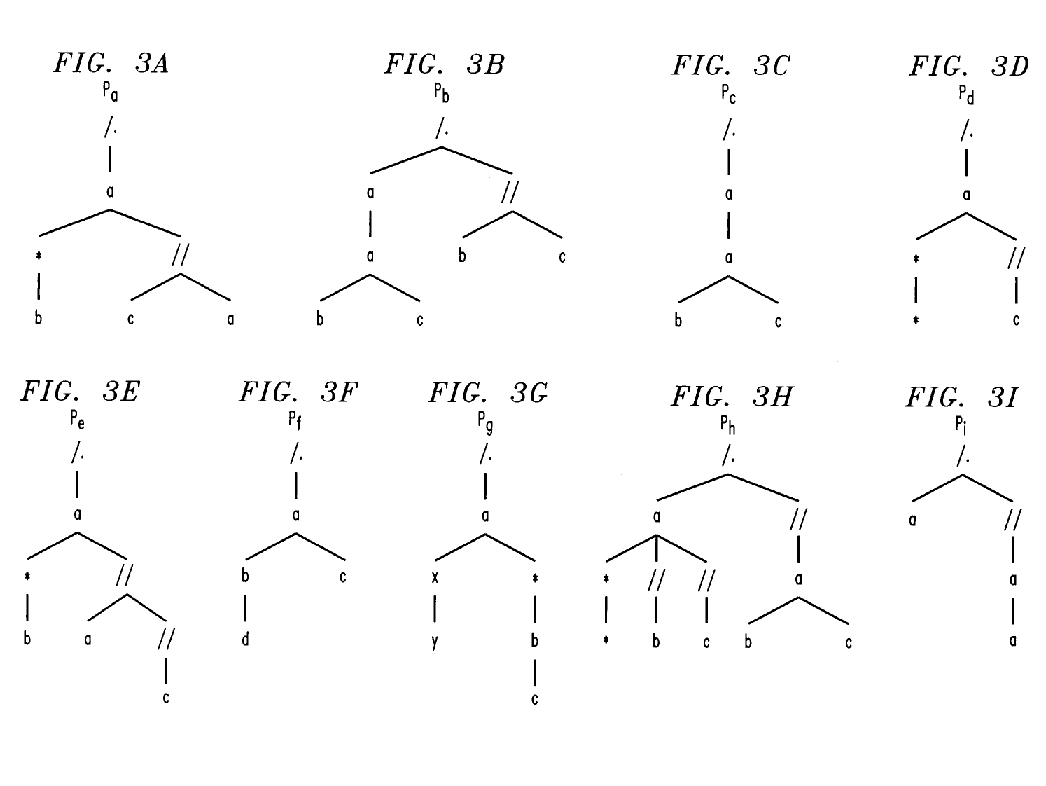

A tree pattern is an unordered node-labeled tree that specifies content and structure conditions on an XML document. More specifically, a tree pattern p has a set of nodes, denoted by Nodes(p), where each node v in Nodes(p) has a label, denoted by label(v), which can either be a tag name, a “*” (wildcard that matches any tag), or a “//” (the descendant operator). In particular, the root node has a special label “/.”. The terminology Subtree (v, p) is used to denote the subtree of p rooted at v, referred to as a sub-pattern of p. Some examples of tree patterns are depicted in FIGS. 3A through 3I.

To define the semantics of a tree pattern p, the semantics are first given of a sub-pattern Subtree (v, p), where v is not the root node of p. Recall that XML documents are typically represented as node-labeled trees, referred to as XML trees. Let T be an XML tree and t be a node in T. It is said that T satisfies Subtree (v, p) at node t, denoted by (T, t) [symbol] Subtree (v, p), if the following conditions hold: (1) if label (v) is a tag, then t has a child node t′ labeled label (v) such that for each child node v′ of v, (T,t′) [symbol] Subtree (v′, p); (2) if label (v)=*, then t has a child node t′ labeled with an arbitrary tag such that for each child node v′ of v, (T,t′) [symbol] Subtree (v′, p); and (3) if label (v)=//, then t has a descendant node t′ (possibly t′=t) such that for each child v′ of v, (T,t′) [symbol] Subtree (v′, p).

The semantics of tree patterns are now defined. Let T be an XML tree with root tᵣₒₒₜ, and p be a tree pattern with root vᵣₒₒₜ. It can be said that T satisfies p, denoted by T [symbol] p, if for each child node v of vᵣₒₒₜ, (1) if label (v) is a tag a, then tᵣₒₒₜ is labeled with a and for each child node v′ of v, (T,tᵣₒₒₜ) [symbol] Subtree (v′, p) (here label (v) specifies the tag of tᵣₒₒₜ); (2) if label (v)=*, then tᵣₒₒₜ may have any label and for each child node v′ of v, (T, tᵣₒₒₜ) [symbol] Subtree (v′, p); (3) if label (v)=//, then tᵣₒₒₜ has a descendant node t′ (possibly t′=tᵣₒₒₜ) such that T′ [symbol] p′, where T′ is the subtree rooted at t′, and p′ is identical to Subtree (v,p) except that “/.” is the label for the root node v (instead of label(v)). Observe that vᵣₒₒₜ is treated differently from the rest of the nodes of p. The motivation behind this is illustrated by pᵢ in FIG. 31, which specifies the following: for any XML tree T satisfying pᵢ, its root must be labeled with a and moreover, it must contain two consecutive a elements somewhere. This generally cannot be expressed without our special root label “/.” (as tree patterns do not allow a union operator).

Consider the tree pattern pₐ in FIG. 3A. An XML document T satisfies pₐ if its root element satisfies all the following conditions: (1) its label is a; (2) it must have a child element with an arbitrary tag, which in turn has a child element with a label b; and (3) it must have a descendant element which has both a c-child element and an a-child element. Thus, pₐ essentially specifies conjunctive conditions on XML documents. It should be noted that documents satisfying pₐ may have tags or subtrees not mentioned in pₐ. For instance, the root element of T may have a d-child element, and the b-elements of T may have c-descendant elements.

A tree pattern p is said to be consistent if and only if there exists an XML document that satisfies p. Generally, only consistent tree patterns are considered herein. Further, the tree patterns defined above can be naturally generalized to accommodate simple conditions and predicates (e.g., issue=“GE” and price<1000). To simplify the discussion, such extensions are not considered herein.

It is worth mentioning that a tree pattern can be easily converted to an equivalent XPath expression in which each sub-pattern is expressed as a condition or qualifier. Thus, tree patterns herein are graph representations of a class of XPath expressions. It is tempting to consider using a larger fragment of Xpath to express subscription patterns. However, it turns out that even a mild generalization of the tree patterns used herein (e.g., with the addition of union/disjunction operators) leads to a much higher complexity (e.g., coNP-hard or beyond) for basic operations such as containment computation.

A tree pattern q is said to be contained in another tree pattern p, denoted by q [symbol] p, if and only if for any XML tree T, if T satisfies q then T also satisfies p. If q [symbol] p, the p is referred to as the container pattern and q as the contained pattern. It is said that p and q are equivalent, denoted by p≡q, if p [symbol] q and q [symbol] p. This definition can be generalized to sets of tree patterns: a set of tree patterns S is contained in another set of tree patterns S′, denoted by S [symbol] S′, if for each pεS, there exists p′εS′ such that p [symbol] p′. Containment for sub-patterns is defined similarly.

The size of a tree pattern p, denoted by |p|, is simply the cardinality of its node set. For example, referring to FIG. 2, |pₐ|=7 and |p_{b}|=8.

2.2 Problem Statement

The tree pattern aggregation problem that we investigate in this paper can now be stated as follows. Given a set of tree patterns S and a space constraint k on the total size of the aggregated subscriptions, compute a set of aggregated patterns S′ that satisfies all of the following three conditions:

(C1) S [symbol] S′ (i.e., S′ is at least as general as S),

(C2) Σ_{p′εS′}|p′|≦k (i.e., S′ is “concise”), and

(C3) S′ is as “precise” as possible, in the sense that there does not exist another set of tree patterns S″ that satisfies the first two conditions and S″ [symbol] S′.

Clearly, the tree pattern aggregation problem may not necessarily have a unique solution since it is possible to have two sets S′ and S″ that satisfy the first two conditions but S′ [symbol] S″ and S″ [symbol] S′. Therefore, it is beneficial to devise a measure to quantify the goodness of candidate solutions in terms of both conciseness as well as preciseness.

With respect to conciseness, the present disclosure considers minimal tree patterns that do not contain any “redundant” nodes. More precisely, it is said that a tree pattern p is minimized if for any tree pattern p′ such that p′≡p, it is the case that |p|≦|p′|. With respect to preciseness, it can be shown that the containment relationship [symbol] on the universe of tree patterns actually defines a lattice. In particular, the notions of upper bound and least upper bound are of relevance to the aggregation problem and, therefore, they are defined formally here.

An upper bound of two tree patterns p and q is a tree pattern u such that p [symbol] u and q [symbol] u, i.e., for any XML tree T, if T [symbol] or T [symbol] q then T [symbol] u. The least upper bound (LUB) of p and q, denoted by p␣u, is an upper bound u of p and q such that, for any upper bound u′ of p and q, u [symbol] u′. Once again, the notion of LUBs is generalized to a set S of tree patterns. An upper bound of S is a tree pattern U, denoted by S [symbol] U, such that p [symbol] U for every pεS. The LUB of S, denoted by ␣S, is an upper bound U of S such that for any upper bound U′ of S, U [symbol] U′.

Clearly, if p is an aggregate tree pattern for a set of tree patterns S (i.e., S [symbol] p), then p is an upper bound of S. Observe that, if p is the LUB of S, then p is the most precise aggregate tree pattern for S. In fact, it can be shown that ␣S exists and is unique up to equivalence for any set S of tree patterns; thus, it is meaningful to talk about US as the most precise aggregate tree pattern.

Consider again the tree patterns in FIGS. 3A through 3I. Observe that P_{b}≡p_{c}; and since |p_{b}|>|p_{c}|, p_{b} is not a minimized pattern. In fact, except for p_{b}, shown in FIG. 3B, all the tree patterns in FIGS. 3A through 3I are minimized patterns. Note that pₐ [symbol] p_{c} because the root node of pₐ does not have a tag-a child node; and p_{c} [symbol] pₐ because there exists no node in p_{c} that is a parent node of both a tag-a-node and a tag-c-node. Observe that pₐ [symbol] p_{d} and p_{c} [symbol] p_{d}; i.e., Pd is an upper bound of pₐ and p_{c}. However, p_{d}≠pₐ␣p_{c} since another tree pattern, pₑ, exists which is an upper bound of pₐ and p_{c} such that pₑ [symbol] p_{d}. Indeed, pₑ=pₐ␣p_{c} with |pₑ|<|pₐ|+|p_{c}|. Note, however, that the size of an LUB is not necessarily always smaller than the size of its constituent patterns. For example, pₕ=p_{c}␣p_{f} but |pₕ|>|p_{c}|+|p_{f}|. Note that p_{d} is an upper bound of {pₐ, p_{b}, p_{c}, pₑ, p_{f}, p_{g}, pₕ}.

This section is concluded by presenting some additional notation used herein. For a node v in a tree pattern p, the set of child nodes of v in p is denoted by Child(v,p). A partial ordering [symbol] is defined on node labels such that if x and x′ are tag names, then (1) x [symbol] *x′ [symbol] // and (2) x [symbol] x′ .iff x=x′. Given two nodes v and w, MaxLabel (v,w) is defined to be the “least upper bound” of their labels label(v) and label(w) as follows:

$$MaxLabel ( v , w ) = \{ \begin{matrix}label ( v ) & if label ( v ) = label ( w ) , \\ // & if ( label ( v ) = // ) \\ & or ( label ( w ) = // ) , \\ * & otherwise .\end{matrix}$$

For example, MaxLabel (a,b)=* and MaxLabel (*,//)=//. For notational convenience, anode v in a tree pattern is referred to as an l-node if label(v)=l, and v is referred to as a tag-node if label(v)∉{/.,*,//}.

3. Computing Precise Aggregates

In this section, a special case of our tree pattern aggregation problem is considered. Namely, when the aggregate set S′ consists of a single tree pattern and there is no space constraint. For this case, methods are described to compute the most precise aggregate tree pattern (i.e., LUB) for a set of tree patterns. Some of the methods given in this section are also key components of a solution for the general problem, which is presented in the next section.

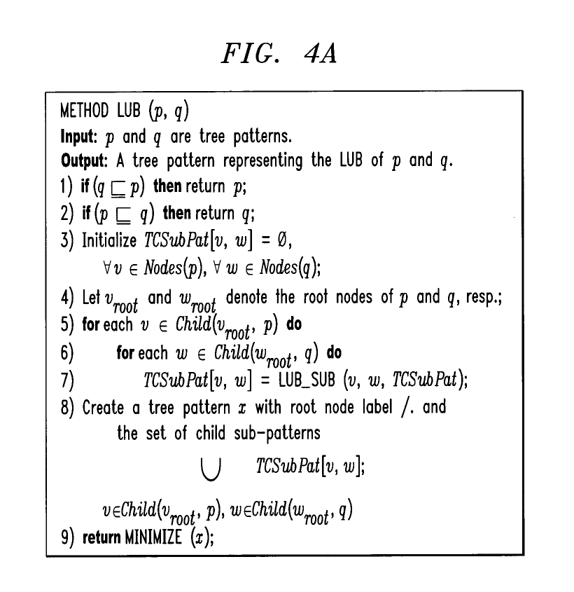

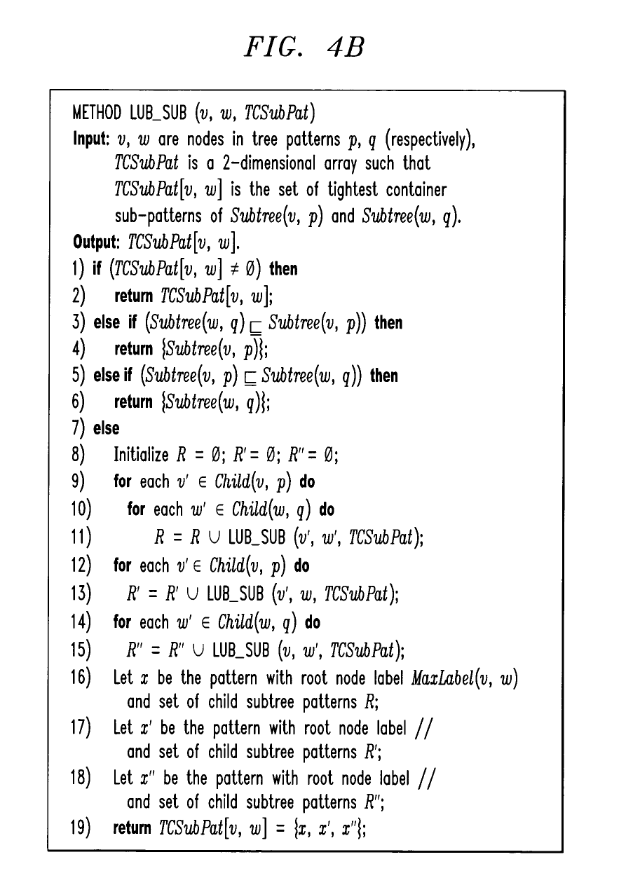

Given two input tree patterns p and q, Method LUB in FIG. 4A computes the most precise aggregate tree pattern for {p,q} (i.e., the LUB of p and q). It traverses p and q top-down and computes the tightest container sub-patterns for each pair of sub-patterns p′=Subtree(v,p) and q′=Subtree(w,q) encountered, where v and w are nodes in p and q, respectively. The tightest container sub-patterns of p′ and q′ are a set R of sub-patterns such that:

(1) R consists of container sub-patterns of p′ and q′, i.e., for any XML document T and any element t in T, if (T,t) [symbol] p′ or (T,t) [symbol] q′ then (T,t) [symbol] r for each rεR; and,

(2) R is tightest in the sense that for any other set of container sub-patterns R′ of p′ and q′ that satisfies condition (1), any XML document T and any element t in T, if (T,t) [symbol] r for each rεR then (T,t) [symbol] r′ for all r′εR′.

Intuitively, R is a collection of conditions imposed by both p′ and q′ such that if T satisfies p′ or q′ at t, then T also satisfies the conjunction of these conditions at t. It is now shown how the LUB for p and q can be computed from the tightest container sub-patterns. Let vᵣₒₒₜ and wᵣₒₒₜ be the roots of patterns p and q, respectively. Note that a document T that satisfies p also satisfies, for each vεChild(vᵣₒₒₜ, p), the restriction of p to the root node and only Subtree(v,p). Consequently, a document T that satisfies p or q must also satisfy the pattern x consisting of a root node (with label /.) whose children are the tightest container sub-patterns for each pair Subtree(v,p) and Subtree(w,q), where vεChild(vᵣₒₒₜ, p) and wεChild(wᵣₒₒₜ, q). This pattern x is thus an LUB of p and q.

The main subroutine in the LUB computation (Method LUB_SUB, shown in FIG. 4B) computes the tightest container subpatterns of p′ and q′ as follows. If q′ [symbol] p′ (resp. p′ [symbol] q′), then p′ (resp. q′) is the tightest container sub-pattern; otherwise, the tightest container sub-patterns are a set {x,x′,x″} of sub-patterns, which are defined in the following manner. The root node of x is labeled with MaxLabel(v,w) and the child subtrees of x are the tightest container sub-patterns of each child subtree of p′ and each child subtree of q′. Intuitively, the root of x corresponds to the roots of p′ and q′ (with a label equal to the least upper bound of that of p′ and q′). In other words, x preserves the positions of the corresponding nodes in p′ and q′. However, this “position-preserving” generalization is generally not sufficient since p′ and q′ may have common sub-patterns at different positions relative to their roots. For example, p_{c} and p_{f} in FIGS. 3C and 3F, respectively, have a common sub-pattern rooted at an a-node that has both b-child and a c-child, but this pattern is located at different positions relative to the roots of p_{c} and p_{f}. To capture these “off-position” common sub-patterns, it is beneficial to compute x′ and x″. The child subtrees of x′ are the tightest container sub-patterns of q′ itself and each child subtree of p′; and the label of the root node of x′ is // to accommodate common sub-patterns at different positions relative to the roots of p′ and q′. Similarly, the root node of x″ has label //, and the child subtrees of x″ are the tightest container sub-patterns of p′ itself and each child subtree of q′.

By computing the tightest container sub-patterns recursively, the method computes the LUB of the input tree patterns p and q. By induction on the structures of p and q, the following result can be shown: Given two tree patterns p and q, Method LUB (p,q) computes p␣q.

Consider the following example. Given p_{c} and p_{f} in FIGS. 3C and 3F, respectively, Method LUB returns pₕ (see FIG. 3H), which is indeed p_{c}␣p_{f}. To help explain the computation of pₕ, the notation xₙ is used to refer the n^{th} node (in some tree pattern) that is labeled “x”, where each collection of nodes sharing the same label are ordered based on their pre-order sequence. For example, in pₕ, the terminology //₁ and //₃ is used to refer to the leftmost and rightmost //-nodes, respectively.

Method LUB_SUB (invoked by Method LUB) first extracts the “position reserving” tightest container sub-patterns for Subtree (a₁,p_{c}) and Subtree (a, p_{f}), which yields the sub-pattern Subtree (a₁, Ph) (in steps 9-11 of FIG. 4B). Note that the root node of Subtree (a₁, pₕ) is labeled a because both the root nodes of Subtree (a, pₕ) and Subtree (a, p_{f}) are labeled a. The sub-patterns (a₂, p_{c}) and Subtree (b, p_{f}) however, have quite different structures and thus a “position-preserving” attempt to extract their common sub-patterns only yields Subtree (*₁, pₕ) In particular, the common sub-pattern consisting of an a-node with both a b-child-node and c-child-node is not captured by the above process because they occur at different positions relative to the root nodes of Subtree (a₂, p_{c}) and Subtree (b, p_{f}). To extract such “off-position” common sub-patterns, Method LUB_SUB compares with Subtree (a₁, p_{c}) with Subtree (b,p_{f}) and Subtree (c,p), as well as compares Subtree (a,p_{f}) with Subtree (a₂,p_{c}) (in steps 12-15 of FIG. 4B). Indeed, this yields Subtree (//₃, pₕ) which has a //-root since this common sub-pattern occurs at different positions relative to the root nodes of Subtree (a₁, p_{c}) and Subtree (a, p_{f}).

It should be mentioned that both Subtree (//₁, pₕ) and Subtree (//₂, pₕ) are also produced by the “off-position” processing, as Method LUB_SUB recursively processes the sub-pattern Subtree (a₂,p_{c}) with Subtree (b,P_{f}) and Subtree (c, p_{f}) respectively. Finally, the method removes the redundant nodes in the result tree pattern by using a minimization method (which will be explained shortly) to generate the LUB pₕ.

It is straightforward to show that the LUB operator “␣”, considered as a binary operator, is commutative and associative, i.e., p₁␣p₂=p₂␣p₁ and p₁␣(p₂␣p₃)=(p₁␣p₂)␣p₃. As a result, Method LUB can be naturally extended to compute the LUB of any set of tree patterns. Next, the details of the two auxiliary methods used in Method LUB are explained.

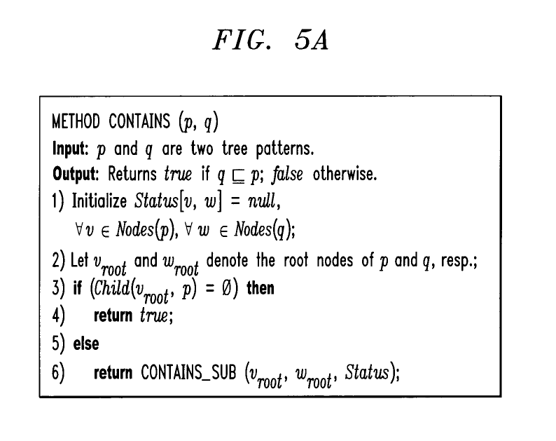

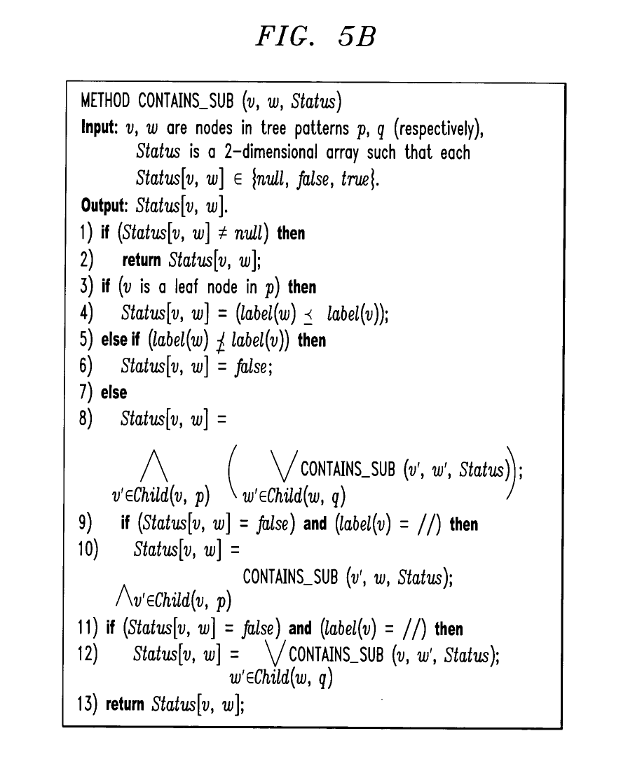

Method LUB needs to check the containment of tree patterns, which is implemented by Method CONTAINS in FIG. 5A. Given two input tree patterns p and q, the method determines if q [symbol] p. It maintains a two-dimensional array Status, which is initialized with Statis[v,w]=null to indicate that vεNodes(p) and wεNodes(q) have not been compared; otherwise, Status[v, w]ε{true, false} such that Status[v, w]=true if and only if Subtree (w,q) [symbol] Subtree(v,p). Clearly, q [symbol] p if and only if Status[vᵣₒₒₜ, wᵣₒₒₜ]=true, where vᵣₒₒₜ and wᵣₒₒₜ denote the root nodes of p and q, respectively.

The main subroutine in our containment method is Method CONTAINS_SUB (see FIG. 5B). Abstractly, CONTAINS_SUB traverses p and q top-down and updates Status[v, w] for each pair of nodes vεNodes(p) and wεNodes(q) visited as follows. Let p′ and q′ denote Subtree(v,p) and Subtree(w,q), respectively. If Status[v,w] has already been computed (i.e., Status[v, w]≠null), then its value is returned. Otherwise, this method determines whether q′εp′, as follows. If label(v)≠//, then Status[v,w]=true iff label(w) [symbol] label(v) and each child subtree of v contains some child subtree of w. Otherwise, if label(v)=//, two additional conditions need to be taken into account. This is because unlike a *-node or a tag-name-node, //-node in a container tree pattern can also be “mapped” to a (possibly empty) chain of nodes in a contained tree pattern. For example, consider the tree patterns p_{d} and p_{f} in FIGS. 3D and 3F, respectively. Note that p_{f} [symbol] p_{d}, and the //-node in p_{d} is not mapped to any node in p_{f} in the sense that p_{f} would still be contained in p_{d} if the //-node in p_{d} is deleted. On the other hand, for the tree patterns p_{d} and p_{g} in FIGS. 3D and 3G, respectfully, p_{g}εp_{d} and the //-node in p_{d} is mapped to both the *- and b-nodes in p_{g} in the sense that Subtree(*, p_{g}) [symbol] Subtree(//, p_{d}) and Subtree(b, p_{g}) [symbol] Subtree(//, p_{d}). These two additional scenarios are handled by steps 10 and 12 in Method CONTAINS_SUB: step 10 accounts for the case where a //-node (v itself) is mapped to an empty chain of nodes, and step 12 for the case where a //-node (v itself) is mapped to a nonempty chain. Note that in steps 8 and 12, the expression P [symbol] w′ inChild(w, q) CONTAINS_SUB (x, w′, Status) returns false if Child(w,q)=φ.

By induction on the structures of p and q, the following result can be shown: Given two tree patterns p and q, Method CONTAINS (p,q) determines if q [symbol] p in O(|p|·|q|) time.

The quadratic time complexity of our tree-pattern containment method is due to, among other things, the fact that each pair of sub-patterns in p and q is checked at most once, because of the use of the Status array. To simplify the discussion, subtle details have omitted from Method CONTAINS. These details involve tree patterns with chains of //- and *-nodes. Such cases require some additional pre-processing to convert the tree pattern to some canonical form, but this does not increase our method's time complexity.

To ensure that tree patterns are concise, identification and elimination of “redundant” nodes are performed. Given a tree pattern p, a minimized tree pattern p′ equivalent to p can be computed using a recursive method MINIMIZE. Starting with the root of p, our minimization method performs the following two steps to minimize the sub-pattern Subtree(v,p) rooted at node v in p: (1) For any v′, v″εChild (v, p), if Subtree(v′, p) [symbol] Subtree(v″, p), then delete Subtree(v′, p) from Subtree(v, p); and, (2) For each v′εChild (v, p) (which was not deleted in the first step), recursively minimize Subtree(v′, p). The complete details can be found in C. Chan, et al., “Tree Pattern Aggregation for Scalable XML Data Dissemination,” Bell Labs Tech. Memorandum (2002), the disclosure of which is hereby incorporated by reference.

It can be shown that Method MINIMIZE minimizes any tree pattern p in O(|p|²) time. It can also be shown that for any minimized tree patterns p and p′, p≡p′ iff p≡p′ (i.e., they are syntactically equal).

Given the low computational complexities of CONTAINS and MINIMIZE, one might expect that this would also be the case for Method LUB. Unfortunately, in the worst case, the size of the (minimized) LUB of two tree patterns can be exponentially large. Implementation results, however, demonstrate that the LUB method exhibits reasonably low average case complexity in practice.

4. Selectivity-Based Aggregation Methods

While the LUB method presented in the previous section can be used to compute a single, most precise aggregate tree pattern for a given set S of patterns, the size of the LUB may be too large and, therefore, may violate the specified space constraint k on the total size of the aggregated subscriptions (Section 2.2). Thus, in order to fit aggregates within the allotted space budget, the requirement of a single precise aggregate is relaxed by permitting a solution to be a set S′={p₁, p₂, . . . pₘ} (instead of a single pattern), such that each pattern qεS is contained in some pattern pᵢεS′. Of course, it is beneficial that S′ provide the “tightest” containment for patterns in S for the given space constraint (Section 2.2); that is, the number of XML documents that satisfy some tree pattern in S′ but not S, is small.

A simple measure of the preciseness of S′ is its selectivity, which is essentially the fraction of filtered XML documents that satisfy some pattern in S′. Thus, an objective is to compute a set S′ of aggregate patterns whose selectivity is very close to that of S. Clearly, the selectivity of tree patterns is highly dependent on the distribution of the underlying collection of XML documents (denoted by D). It is, however, generally infeasible to maintain the detailed distribution D of streaming XML documents for our aggregation—the space requirements would be enormous! Instead, an approach herein is based on building a concise synopsis of D on-line (i.e., as documents are streaming by), and using that synopsis to estimate tree-pattern selectivities. At a high level, an illustrative aggregation method iteratively computes a set S′ that is both selective and satisfies the space constraint, starting with S′=S (i.e., the original set S of patterns), and performing the following sequence of steps in each iteration:

(1) Generate a candidate set of aggregate tree patterns C consisting of patterns in S′ and LUBs of similar pattern pairs in S′.

(2) Prune each pattern p in C by deleting/merging nodes in p in order to reduce its size.

(3) Choose a candidate pattern pεC to replace all patterns in S′ that are contained in p. The candidate-selection strategy is based on marginal gains: The selected candidate p is the one that results in the minimum loss in selectivity per unit reduction in the size of S′ (due to the replacement of patterns in S′ by p).

Note that the pruning step (step 2) above makes candidate aggregate patterns less selective (in addition to decreasing their size). Thus, by replacing patterns in S′ by patterns in C, this effectively tries to reduce the size of S′ by giving up some of its selectivity.

In the following subsections, an exemplary method for computing S′ is described in detail. First, an approach is presented for estimating the selectivity of tree patterns over the underlying document distribution, which is critical to choosing a good replacement candidate in step 3 above.

4.1 Selectivity Estimation for Tree Patterns

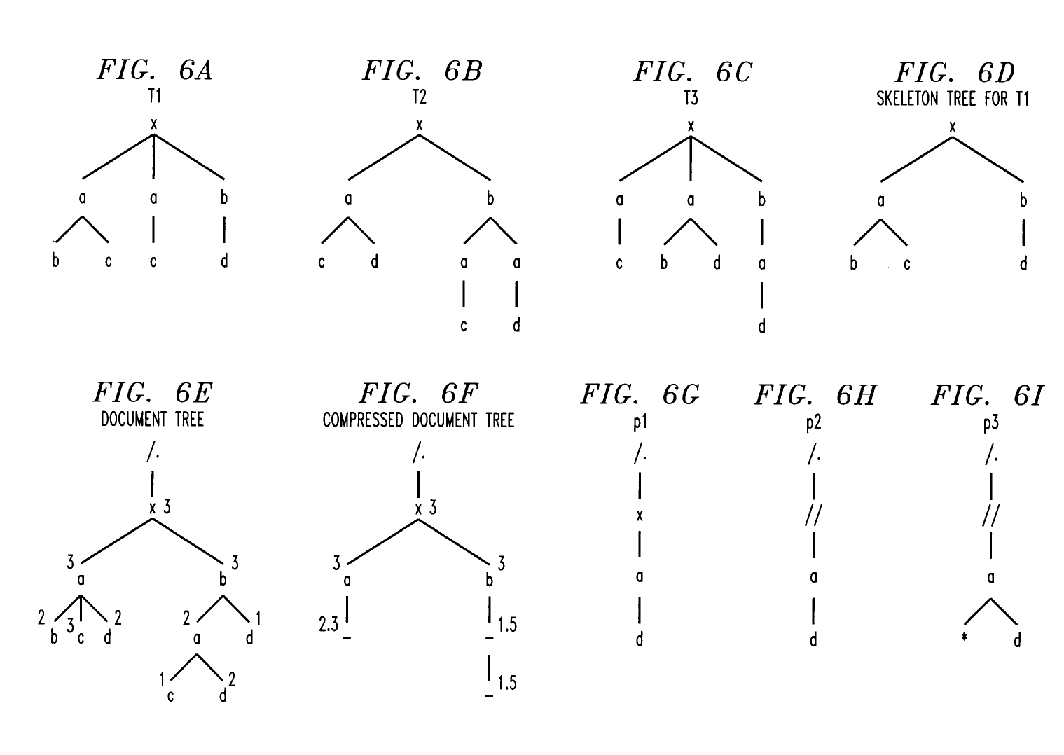

The document tree synopsis is now described. As mentioned above, it is simply impossible to maintain the accurate document distribution D (i.e., the full set of streaming documents) in order to obtain accurate selectivity estimates for our tree patterns. Instead, an exemplary approach is to approximate D by a concise synopsis structure, which is referred to herein as the document tree. A document tree synopsis for D, denoted by DT, captures path statistics for documents in D, and is built on-line as XML documents stream by. The document tree essentially has the same structure as an XML tree, except for two differences. First, the root node of DT has the special label “/.”. Second, each non-root node t in DT has a frequency associated with it, denoted by freq(t). Intuitively, if l₁/l₂/ . . . /lₙ is the sequence of tag names on nodes along the path from the root to t (excluding the label for the root), then freq(t) represents the number of documents T in D that contain a path with tag sequence l₁/l₂/ . . . lₙ originating at the root of T. The frequency for the root node of DT is set to N, the number of documents in D. As XML documents stream by, DT is incrementally maintained as follows. For each arriving document T, the skeleton tree T₈ is first constructed for document T. In the skeleton tree T₈, each node has at most one child with a given tag. T₈ is built from T by simply coalescing two children of a node in T if they share a common tag. Clearly, by traversing nodes in T in a top-down fashion, and coalescing child nodes with common tags, one can construct T₈ from T in a single pass (using an event-based XML parser). As an example, FIG. 6D depicts the skeleton tree for the XML-document tree in FIG. 6A.

Next, T₈ is used to update the statistics maintained in document tree synopsis DT as follows. For each path in T₈, with tag sequence say l₁/l₂/ . . . /lₙ, let t be the last node on the corresponding (unique) path in DT. We increment freq(t). FIG. 6E shows the document tree (with node frequencies) for the XML trees T₁, T₂, and T₃ in FIGS. 6A to 6C. Note that it is possible to further compress DT by using techniques similar to the methods employed by Aboulnaga et al., “Estimating the Selectivity of XML Path Expressions for Internet Scale Applications,” Proc. 27th Intl. Conf. on Very Large Databases (VLDB 2001), the disclosure of which is hereby incorporated by reference, for summarizing path trees. The key idea is to merge nodes with the lowest frequencies and store, with each merged node, the average of the original frequencies for nodes in DT that were merged. This is illustrated in FIG. 6F for the document tree in FIG. 6E, and with the label “-” used to indicate merged nodes. Due to space constraints, in the remainder of this subsection, only solutions are presented to the selectivity estimation problem using the uncompressed tree DT. However, the proposed methods can be easily extended to work even when DT is compressed.

It should be noted that a selectivity estimation problem for tree patterns differs from the work of Aboulnaga in two important respects. First, in Aboulnaga, the authors consider the problem of estimating selectivity for only simple paths that consist of a //-node followed by tag nodes. In contrast, here selectivities are estimated of general tree patterns with branches, and *- or //-nodes arbitrarily distributed in the tree. Second, selectivity at the granularity of documents is important herein, so a goal is to estimate the number of XML documents that match a tree pattern; instead, Aboulnaga addresses the selectivity problem at the granularity of individual document elements that are discovered by a path. It can be seen that these are two very different estimation problems.

A selectivity estimation procedure is now described. Recall that the selectivity of a tree pattern p is the fraction of documents T in D that satisfy p. By construction, a DT synopsis gives accurate selectivity estimates for tree patterns comprising a single chain of tag-nodes (i.e., with no * or //). However, obtaining accurate selectivity estimates for arbitrary tree patterns with branches, *, and // is, in general, not possible with DT summaries. This is because, while DT captures the number of documents containing a single path, it does not store document identities. As a result, for a pair of arbitrary paths in a tree pattern, it is generally hard to determine the exact number of documents that contain both paths or documents that contain one path, but not the other.

An exemplary estimation procedure solves this problem, by making the following simplifying assumption: The distribution of each path in a tree pattern is independent of other paths. Thus, selectivity is estimated of a tree pattern containing no // or * labels, simply as the product of the selectivities of each root to leaf path in the pattern. For patterns containing // or *, all possible instantiations are considered for // and * with element tags, and then chosen as a pattern selectivity the maximum selectivity value over all instantiations. Selectivity estimation methodology is illustrated in the following example.

Consider the problem of estimating the selectivities of the tree patterns shown in FIGS. 6G to 6I using the document tree shown in FIG. 6E. The total number of documents, N, is 3. Clearly, the number of documents satisfying pattern P₁ which consists of a single path, can be estimated accurately by following the path in DT and returning the frequency for the D-node (at the end of the path) in DT. Thus, the selectivity of P₁ is 2/3 which is accurate since only documents T₂ and T₃ satisfy P₁. Estimating the number of documents containing pattern P₂, however, is somewhat more difficult. This is because there are two paths with tag sequences x/a/d/ and x/b/a/d in DT that match p₂ (corresponding to instantiating // with x and x/a). Summing the frequencies for the two d-nodes at the end of these paths gives an answer of 4 which over-estimates the number of documents satisfying p₂ (only documents T₂ and T₃ satisfy p₂). To avoid double-counting frequencies, one can estimate the number of documents satisfying p₂ to be the maximum (and not the sum) of frequencies over all paths in DT that match p₂. Thus, the selectivity of p₂ is estimated as 2/3.

Finally, the selectivity of p₃ is computed by considering all possible instantiations for // and *, and choosing the one with the maximum selectivity. The two possible instantiations for // that result in non-zero selectivities are x and x/b, and * can be instantiated with either b, c or d for //=x, and c or d for //=x/b. Choosing //=x and *=c results in the maximum selectivity since the product of the selectivities of paths x/a/c and x/a/d is maximum, and is equal to (3/3)·(2/3)=2/3.

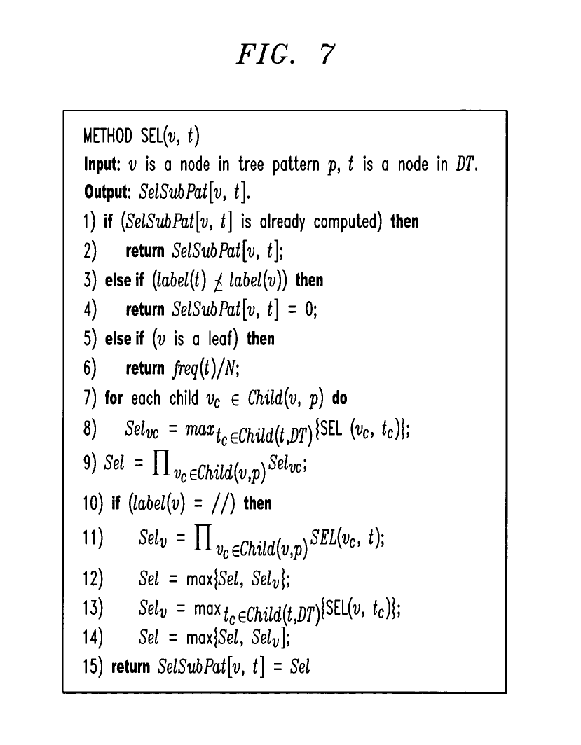

Method SEL (depicted in FIG. 7), invoked with input parameters v=vᵣₒₒₜ (root of pattern p) and t=tᵣₒₒₜ (root of DT), computes the selectivity for an arbitrary tree pattern p in O(|DT|·|p|) time. In the method, for nodes vεp and tεDT, SelSubPat[v,t] stores the selectivity of the sub-pattern Subtree(v,p) with respect to the subtree of DT rooted at node T. This selectivity is estimated similar to the selectivity for pattern P, except that now consider all instantiations of Subtree(v,p) (obtained by instantiating // and * with element tags) are considered, and the selectivity of each instantiation is computed with respect to t as the root instead of the root of DT. For instance, suppose that V is the a-node in p₃ (in FIG. 6I), and t is the child a-node of the x-node in DT (in FIG. 6E). Then, the selectivity of Subtree (v, p₃) with respect to t is essentially the product of the selectivity of paths a/* and a/d with respect to node t, which is 1·(2/3). Thus, SelSubPat[v, t]=2/3.

A goal is to compute SelSubPat[vᵣₒₒₜ, tᵣₒₒₜ]. For a pair of nodes v and t, Method SEL computes SelSubPat[v,t] from SelSubPat[ ] values for the children of v and t. Clearly, if label(t) [symbol] label(v) (steps 3-4 of the method), then every path in Subtree(v,p) begins with a label different from label(t) and thus the selectivity of each of the paths is 0. If label(t) [symbol] label(v) and v is a leaf (steps 5-6), then instantiate label(v) (if label(v)=// or*), with label(t) giving a selectivity of freq(t)/N. On the other hand, if v is an internal node of p, then in addition to instantiating label(v) with label(t), one also needs to compute, for every child v_{c} of v, the instantiation for Subtree(v_{c},p) that has the maximum selectivity with respect to some child t_{c} of t. Since SelSubPat[v_{c},t_{c}] is the selectivity of Subtree(v_{c}, p) with respect to t_{c}, the product of maxₜ_{_{c}}_{εChild(t,DT)} SelSubPat[v_{c},t_{c}] for the children v_{c} of v gives the selectivity of Subtree(v,p) with respect to t. Finally, if label(v)=//, then // can be simply null, in which case the selectivity of Subtree(v,p) with respect to t is computed as described in step 11, or // is instantiated to a sequence consisting of label(t) followed by label(t_{c}), where t_{c} is the child of t such that the selectivity of Subtree(v,p) with respect to t_{c} is maximized (Step 13). Observe that, in steps 8 and 13, if t has no children, then maxₜ_{_{c}}_{εChild(t,DT)}{ . . . } evaluates to 0.

4.2 Tree Pattern Aggregation Method

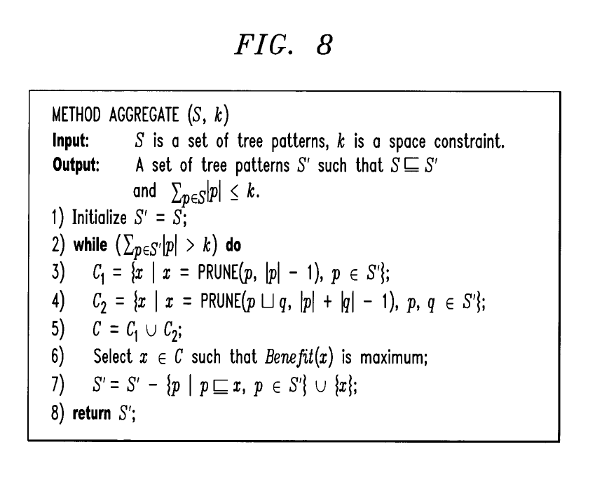

A “greedy” heuristic method is now presented for the tree pattern aggregation problem defined in Section 2.2 (which is, in general, an NP-hard clustering problem). As described earlier, to aggregate an input set of tree patterns S into a space-efficient and precise set, the method (Method AGGREGATE in FIG. 8) iteratively prunes the tree patterns in S by replacing a small subset of tree patterns with a more concise upper-bound aggregate pattern, until S satisfies the given space constraint. During each iteration, the method first generates a small set of potential candidate aggregate patterns C, and selects from these the (locally) “best” candidate pattern, i.e., the candidate that maximizes the gain in space while minimizing the expected loss in selectivity.

Candidate generation is now described. An exemplary process is described for generating the candidate set C in steps 3-5 of Method AGGREGATE. To reduce the size of individual candidate patterns of the form p or p␣q, each candidate is pruned by invoking Method PRUNE (details in “Tree Pattern Aggregation for Scalable XML Data Dissemination”). Given an input pattern p and space constraint n, Method PRUNE prunes p to a smaller tree pattern p′ such that p [symbol] p′ and |p′|≦n. The method treats tag-nodes as more selective than *- and //-nodes, and therefore tries to prune away *- and //-nodes before the tag-nodes. Specifically, the method first prunes the *- and //-nodes in p by (1) replacing each adjacent pair of non-tag-nodes v,w with a single //-node, if w is the only child of v, and (2) eliminating subtrees that consist of only non-tag-nodes. If the tree pattern is still not small enough after the pruning of the nontag-nodes, start pruning the tag-nodes. There are two ways to reduce the size of a tree pattern p by one node. The first is to delete some leaf node in p, and the second is to collapse two nodes v and w into a single //-node, where label(v)≠/· and Child(v,p)={w}. To help select a “good” leaf node to delete (or, pair of nodes to collapse), make use of the selectivity of the tag names. More specifically, use the document tree synopsis DT to estimate the total number of occurrences of a tag name in the document collection D, and then choose the tags with higher total frequencies (which are less selective) as candidates for pruning.

Candidate selection is now described. Once the set of candidate aggregate patterns has been generated, some criterion is beneficial for selecting the “best” candidate to insert into S′. For this purpose, associate a benefit value with each candidate aggregate pattern xεC, denoted by Benefit(x), based on its marginal gain; that is, define Benefit(x) as the ratio of the savings in space to the loss in selectivity of using x over {p|p [symbol] x,pεS′}. More formally, if vₓ_{ᵣₒₒₜ},tᵣₒₒₜ and vₚ_{ᵣₒₒₜ} represent the root nodes of x, DT, and pεS′, then Benefit(x) is equal to:

$$\frac{( {\sum }_{p ⊆ x , p ∈ {S}^{′}}^{} \vert p \vert ) - \vert x \vert}{SEL ( {v}_{{x}_{root}} , {t}_{root} ) - {max}_{p ⊆ x , p ∈ {S}^{′}} SEL ( {v}_{{p}_{root}} , {t}_{root} )}$$

Note that the selectivity loss is computed by comparing the selectivity of the candidate aggregate pattern x with that of the least selective pattern contained in it. This gives a good approximation of the selectivity loss in cases when the patterns p,qεS′ used to generate x are similar and overlap in the document tree DT. The candidate aggregate pattern with the highest benefit value is chosen to replace the patterns contained in it in S′ (steps 6-7 of FIG. 8). Experimental data relating to the present invention may be found in C. Chan et al., “Tree Pattern Aggregation for Scalable XML Data Dissemination,” The 28th Int'l Conf. on Very Large Data Bases (2002), the disclosure of which is hereby incorporated by reference.

It is to be understood that the embodiments and variations shown and described herein are merely illustrative of the principles of this invention and that various modifications may be implemented by those skilled in the art without departing from the scope and spirit of the invention. For example, the subscriptions could contain both tree patterns and non-tree patterns. The various assumptions made herein are for the purposes of simplicity and clarity of illustration, and should not be construed as requirements of the present invention.

We claim:

1. In a communication system, a method for information dissemination, the method comprising the steps of:
providing a set of subscriptions, at least one of the set of subscriptions comprising a tree pattern, wherein the tree pattern comprises one or more interconnected nodes having a hierarchy and adapted to specify content and structure of information; and
using the set of subscriptions to select information for dissemination to one or more users.

2. The method of claim 1, wherein the at least one subscription describes information the one or more users are interested in receiving.

3. The method of claim 1, further comprising the step of determining an aggregation from the set of subscriptions, the aggregation comprising a set of aggregate patterns, wherein the set of aggregate patterns is smaller than the set of subscriptions, and wherein the step of using the set of subscriptions to select information for dissemination further comprises using the set of aggregate patterns to select the information for dissemination to the one or more users.

4. The method of claim 1, wherein the information comprises one or more documents defined using extensible markup language (XML).

5. The method of claim 3, wherein at least one of the aggregate patterns and the tree pattern each is defined using extensible markup language (XML).

6. The method of claim 3, wherein each aggregate pattern and each subscription comprises a tree pattern having one or more interconnected nodes having a hierarchy, and wherein the set of aggregate patterns is smaller than the set of subscriptions in that a number of aggregate patterns in the set of aggregate patterns is smaller than a number of tree patterns in the set of subscriptions and that a number of nodes in the set of aggregate patterns is smaller than a number of nodes in the set of subscriptions.

7. The method of claim 3, wherein the step of determining an aggregation further comprises the step of determining the aggregation from the set of subscriptions by using at least a space constraint.

8. The method of claim 7, wherein the space constraint comprises a predetermined number of bytes.

9. The method of claim 3, wherein the set of subscriptions comprises a plurality of tree patterns, each of the tree patterns comprising one or more interconnected nodes having a hierarchy and adapted to specify content and structure of information, and wherein the step of determining an aggregation further comprises the step of determining a least upper bound pattern for two of the plurality of tree patterns in the set of subscriptions, the least upper bound pattern chosen as an aggregate pattern.

10. The method of claim 9, wherein the two tree patterns are a first tree pattern and a second tree pattern, and wherein the step of determining a least upper bound pattern further comprises the steps of:
if the first tree pattern is contained in the second tree pattern, setting the least upper bound pattern to be the first tree pattern;
if the second tree pattern is contained in the first tree pattern, setting the least upper bound pattern to be the second tree pattern;
traversing the first and second tree patterns and computing a tightest container pattern by:
computing a position-preserving tightest container pattern by finding common sub-patterns;
computing an off-position tightest container pattern by finding common sub-patterns; and
constructing the tightest container pattern by taking a union of the position-preserving tightest container pattern and the off-position tightest container pattern,
wherein the tightest container pattern is used as the least upper bound pattern.

11. The method of claim 9, wherein the step of determining a least upper bound pattern for two of the plurality of tree patterns further comprises the steps of determining a tightest container pattern for the two tree patterns and minimizing the tightest container pattern to create a minimal pattern, wherein the minimal pattern is used as the least upper bound pattern.

12. The method of claim 3, wherein the set of subscriptions comprises a plurality of tree patterns, wherein each tree pattern in the set of subscriptions comprises one or more interconnected nodes having a hierarchy and adapted to specify content and structure of information, and wherein the step of determining an aggregation further comprises the steps of:
designating a candidate set of tree patterns to be the plurality of tree patterns;
performing the following steps:
identifying a set of candidate aggregate patterns from the plurality of tree patterns and similar tree patterns determined from the candidate set of tree patterns;
pruning each candidate aggregate pattern by deleting or merging nodes;
selecting a chosen tree pattern from the candidate aggregate patterns having a predetermined marginal gain; and
replacing all tree patterns, in the candidate set of tree patterns, that are contained in the chosen tree pattern by the chosen tree pattern.

13. The method of claim 12, wherein the marginal gain is determined by a benefit value of a tree pattern.

14. The method of claim 13, wherein the candidate set of tree patterns occupies a space and wherein the benefit value is determined from a ratio of savings in the space for a corresponding tree pattern to a loss in selectivity for the corresponding tree pattern.

15. The method of claim 14, wherein the selectivity is determined by sampling matching of information to candidate patterns.

16. In a communication system, an apparatus for providing information dissemination, the apparatus comprising:
a memory; and
at least one processor, coupled to the memory;
the apparatus operative:
to provide a set of subscriptions, at least one of the set of subscriptions comprising a tree pattern, wherein the tree pattern comprises one or more interconnected nodes having a hierarchy and adapted to specify content and structure of information; and
to use the set of subscriptions to select information for dissemination to one or more users.

17. An article of manufacture for providing information dissemination, the article of manufacture comprising:
a machine readable medium containing one or more programs which when executed implement the steps of:
providing a set of subscriptions, at least one of the set of subscriptions comprising a tree pattern, wherein the tree pattern comprises one or more interconnected nodes having a hierarchy and adapted to specify content and structure of information; and
using the set of subscriptions to select information for dissemination to one or more users.
